(19) United States
(12) Patent Application Publication
(10) Pub. No.: US 2025/0180519 A1
(43) Pub. Date: Jun. 5, 2025

(54) METHOD FOR AUTOMATIC CALIBRATION OF AN ULTRASOUND TRANSDUCER

(71) Applicant: COMMISSARIAT A L’ENERGIE ATOMIQUE ET AUX ENERGIES ALTERNATIVES, PARIS (FR)

(72) Inventors: David ROUE, GIF-SUR-YVETTE (FR); Ekaterina IAKOVLEVA, GIF-SUR-YVETTE (FR)

(21) Appl. No.: 18/951,411

(22) Filed: Nov. 18, 2024

(30) Foreign Application Priority Data
Nov. 30, 2023 (FR) 2313317

(51) Int. Cl. G01N 29/30; G01N 29/06; G01N 29/44

(52) U.S. Cl. CPC G01N 29/30; G01N 29/069; G01N 29/4463

(57) ABSTRACT

A computer-implemented method is provided for the calibration of ultrasound signals acquired by a multi-element ultrasound transducer for the purpose of imaging an area of interest. The method includes the steps of: estimating an ultrasound field emitted from the transducer towards any point P of the area, estimating an ultrasound field, originating from the point P, acquired by the transducer, determining an elementary signal received by the transducer on the basis of the emitted ultrasound field and the acquired ultrasound field, determining on the basis of the elementary signal, for each point P of the area, a calibration coefficient to be applied to the signals received by an ultrasound transducer in order to image the area, or to an ultrasound image obtained on the basis of the received signals.

### CROSS-REFERENCE TO RELATED APPLICATION

This application claims priority to foreign French patent application No. FR 2313317, filed on Nov. 30, 2023, the disclosure of which is incorporated by reference in its entirety.

### FIELD OF THE INVENTION

The invention relates to the field of ultrasonic non-destructive testing for the purpose of carrying out the imaging or echography of a part to be inspected, using a multi-element ultrasound transducer.

More specifically, the invention relates to a method of automatic calibration of the amplitude of such a transducer prior to its use.

### BACKGROUND

A general objective of non-destructive testing is that of providing an image of a part in order to identify defects within said part. Defects may be likened to reflectors, from which the waves are reflected and then backscattered to the transducer which measures them.

This process implies that ultrasonic non-destructive testing of a part is based on relative measurements. In fact, the measured amplitude shows an attenuation which is a function of the distance between a reflector within the part and the emitting element of the transducer. This attenuation must be corrected, since the aim is to characterize the reflectors regardless of their distance from the transducer.

A calibration procedure must therefore be established, to ensure that all the potential reflectors of a part result in a uniform amplitude in the received signals, regardless of the depth of the reflector. To this end, the testing device must be calibrated on reference measurements before a new part can be inspected.

The prior art calibration methods are based on the generation of signal amplitude correction curves as a function of time for each element of a transducer and each angle of incidence of the emitted signal. These curves are plotted on the basis of measurements made on a reference part comprising artificial reflectors located at predefined points of the part, at different depths. For these measurements, the transducer must be placed in different positions and orientations with respect to the part, in order to obtain complete calibration curves. The measurements therefore require the intervention of a human operator, who must make a plurality of successive measurements, repositioning the transducer relative to the reference part every time. The signal amplitude correction curves are determined as a function of time in such a way that reflectors of equal size yield uniform amplitude responses for all depths and positions of these reflectors.

The drawback of this method is that it is difficult and time-consuming to implement, and requires the intervention of a human operator. Consequently, the precision of the resulting calibration curves depends on the precision of the operator's placing of the transducer. Furthermore, the resulting curves require interpolation in order to find all the values of gain as a function of depth, since the number of reflectors in the reference part is limited.

Thus there is a need for an automated calibration method that is simple and quick to implement, does not require the intervention of a human operator, and is more precise.

### SUMMARY OF THE INVENTION

The invention relates to a novel method of automatic calibration which is based on the determination of a correction map, calculated for every point of an area to be imaged on the basis of an ultrasonic field model. Consequently it requires neither the intervention of an operator nor any preliminary measurements. The invention thus has the advantage of improving the precision and speed of the calibration step. It is compatible with a plurality of ultrasonic imaging methods, notably the TFM (Total Focusing Method) and PWI (Plane Wave Imaging) acquisition methods.

The invention relates to a computer-implemented method for the calibration of ultrasound signals acquired by a multi-element ultrasound transducer for the purpose of imaging an area of interest, the method comprising the steps of:
estimating an ultrasound field emitted from the transducer towards any point P of said area,
estimating an ultrasound field, originating from said point P, acquired by the transducer,
determining an elementary signal received by the transducer on the basis of the emitted ultrasound field and the acquired ultrasound field,
determining, on the basis of said elementary signal, for each point P of said area, a calibration coefficient to be applied to the signals received by an ultrasound transducer in order to image said area, or to an ultrasound image obtained on the basis of said received signals.

According to a variant embodiment, the method according to the invention further comprises the steps of:
performing ultrasound imaging of the area of interest by means of the ultrasound transducer,
correcting the signals received by the ultrasound transducer or the image determined on the basis of said signals, using the calculated calibration coefficients.

According to a particular aspect of the invention, the steps of estimating an ultrasound field comprise the projection of the estimated ultrasound field on to a polarization vector of the ultrasonic wave.

According to a particular aspect of the invention,
the elementary signal associated with a pair of elements (emitter and receiver) of the transducer is taken to be equal to the temporal convolution product of the ultrasound field emitted from the emitter element towards the point P and the ultrasound field acquired by the receiver element from the point P,
the calibration coefficient is taken to be equal to the sum, over the set of elements of the transducer, of the values of the elementary signal taken at instants equal to the sum of the time of flight of an ultrasonic wave between an emitter element of the transducer and the point P and the time of flight of an ultrasonic wave between the point P and a receiver element of the transducer,
the calibration coefficient being applied to the pixel, corresponding to the point P, of an ultrasound image obtained via a total focusing method.

According to a particular aspect of the invention, the ultrasound transducer is capable of emitting a plane wave at a given angle of incidence, and the ultrasound field emitted by the transducer at the angle of incidence towards the point P is taken to be equal to the sum of the values of the ultrasound fields emitted from an element of the transducer towards the point P, taken at an instant delayed by a predefined delay so that the transducer emits a plane wave at said angle of incidence.

According to a particular aspect of the invention,
the elementary signal associated with a pair (angle of incidence, receiver element of the transducer) is taken to be equal to the temporal convolution product of the ultrasound field emitted by the transducer at the angle of incidence towards the point P and the ultrasound field acquired by the receiver element from the point P,
the calibration coefficient is taken to be equal to the sum, over a plurality of angles of incidence and the set of elements of the transducer, of the values of the elementary signal taken at instants equal to the sum of the time of flight of a plane wave emitted at a given angle of incidence towards the point P and the time of flight of an ultrasonic wave between the point P and a receiver element of the transducer,
the calibration coefficient being applied to the pixel, corresponding to the point P, of an ultrasound image obtained via a plane wave ultrasound imaging method.

According to a particular aspect of the invention, the ultrasound image is a sum of the signals acquired by the elements of the transducer taken at the times of flight corresponding to a point P of the area to be imaged.

According to a particular aspect of the invention,
the elementary signal associated with an angle of incidence is taken to be equal to the temporal convolution product of the ultrasound field emitted by the transducer at the angle of incidence towards a point located on a representative ray of the propagation of the plane wave and the ultrasound field emitted from said point towards the transducer.
each ultrasound signal acquired by the transducer for a given angle of incidence and a given time of flight is corrected by the calibration coefficient taken to be equal to the elementary signal taken at an instant equal to the time of flight.

According to a particular aspect of the invention, the ultrasound image is defined by a representation of the signals acquired as a function of the angle of incidence and the time of flight.

The invention also relates to an ultrasound imaging device comprising a multi-element ultrasound transducer and a processing unit, configured for implementing the steps of the calibration method according to the invention.

The invention also relates to a computer program comprising instructions which cause the device according to the invention to execute the steps of the calibration method according to the invention.

### BRIEF DESCRIPTION OF THE DRAWINGS

Other characteristics and advantages of the present invention will be more readily apparent from a perusal of the following description, relating to the following attached drawings.

FIG. 1 shows, in a flow chart, the steps of the implementation of a calibration method applied to a first method for acquiring ultrasound signals, according to the prior art,

FIG. 2 shows, in a flow chart, the steps of the implementation of a second calibration method applied to a TFM or PWI ultrasound imaging method, according to the prior art,

FIG. 3 shows an example of an interface of a calibration assistant according to the prior art,

FIG. 4a shows a first example of experimental calibration curves obtained by the calibration method of FIG. 1 for different orientations of the transducer,

FIG. 4b shows a second example of experimental calibration curves obtained by the calibration method of FIG. 1 for different orientations of the transducer,

FIG. 5 shows, in a flow chart, the steps of the implementation of an automated calibration method applied to TFM or PWI imaging according to one embodiment of the invention,

FIG. 6 shows, in a flow chart, the steps of the implementation of the method of calculating a correction map used by the calibration method of FIG. 5,

FIG. 7 illustrates the application of the method according to the invention for TFM ultrasound imaging,

FIG. 8 illustrates a diagram of a configuration of ultrasound imaging by angular scanning,

FIG. 9 shows, in a flow chart, the steps of the implementation of an automated calibration method applied to ultrasound imaging by angular scanning according to one embodiment of the invention,

FIG. 10 shows, in a flow chart, the steps of the implementation of the method of calculating the calibration coefficients used by the method of FIG. 9,

FIG. 11 shows a diagram illustrating a representative ray of the propagation of an ultrasonic wave,

FIG. 12 shows an example of signals corrected by means of the method described in FIGS. 9 and 10,

FIG. 13 shows a diagram of an ultrasound imaging system capable of implementing the invention.

### DETAILED DESCRIPTION

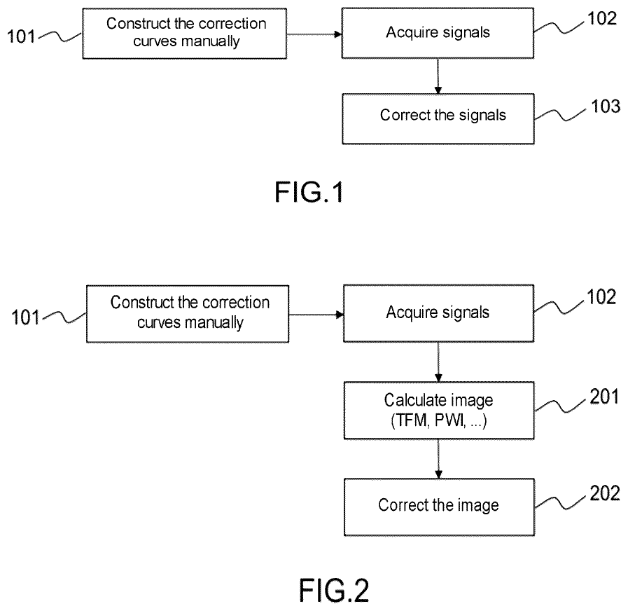

FIG. 1 illustrates an ultrasound transducer calibration procedure according to the prior art applied to the acquisition of ultrasound signals.

An ultrasound signal acquisition method is based on the use of a multi-element transducer associated with focusing in emission and/or in reception by the application of delay laws to the elements of the transducer. This application may require angular scanning of the ultrasound signals and focusing at one or more points. A plane wave is generated by the transducer at an angle of incidence towards a part to be inspected. This wave is reflected from reflectors comprised in the part, then propagated towards the transducer, operating in reception mode, which performs the acquisition of the reflected signals.

As indicated above, the acquired signals require amplitude calibration as a function of the time of flight related to the distance between the transducer and the reflectors in the part.

This calibration method comprises a first step 101 of constructing gain correction curves for different angles of emission of the ultrasound signals. In a second step 102, ultrasound signals are measured by a transducer for the purpose of testing a part. The calibration curves are then used to correct (step 103) the amplitude signals acquired as a function of time, in order to ensure that all the reflectors have a uniform amplitude according to their depth. This calibration is therefore performed for each of the signals received by the transducer.

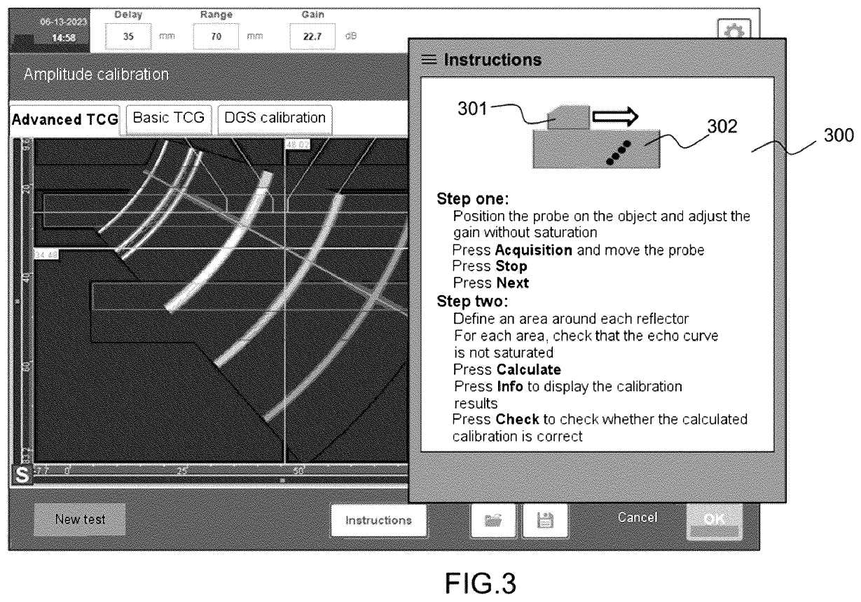

Step 101 of constructing the gain correction curves requires a protocol for the measurements made by an operator. At each step of the protocol, the operator moves the transducer relative to a reference part which comprises reflectors positioned at different depths. For this purpose, he may be assisted by a software assistant of the type described in FIG. 3.

In box 300, instructions for the operator are displayed to inform him of the protocol to be followed.

This protocol consists in performing a plurality of successive acquisitions via a multi-element transducer 301 positioned relative to a reference part 302. The reference part comprises lateral holes with different depths, acting as reflectors for the ultrasonic waves emitted by the transducer.

At each step, the operator performs an ultrasonic acquisition for one position of the transducer and one angular orientation relative to the part.

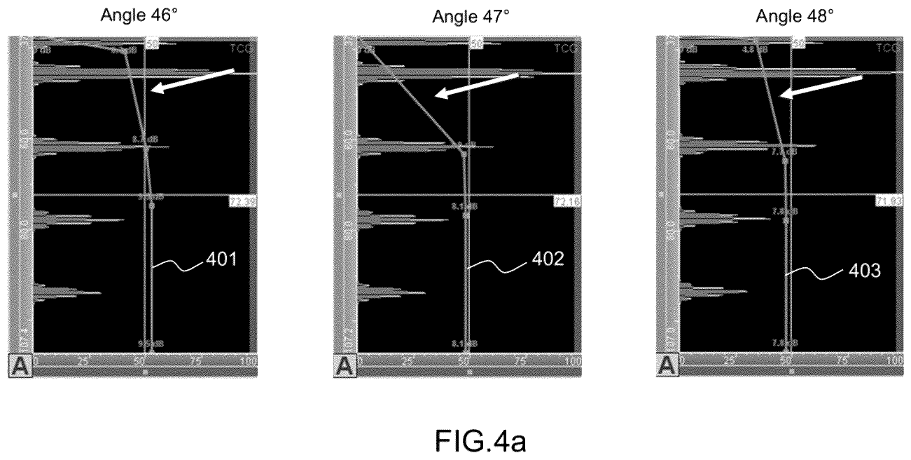

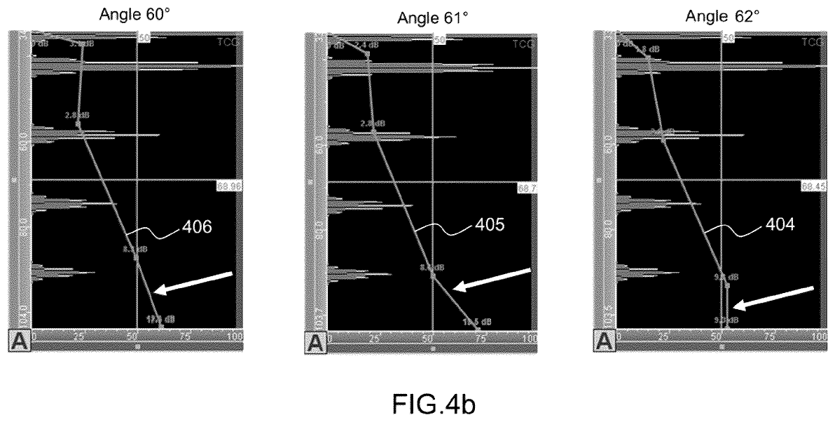

FIGS. 4a and 4b show an example of a plurality of calibration curves obtained by this protocol for different angles of incidence of the plane wave generated by the transducer, equal to 46°, 47°, 48°, 60°, 61° and 62°, respectively.

Each diagram of FIGS. 4a and 4b shows the amplitude of the signal on the horizontal axis and the time of flight, or distance between the emitter and a reflector, on the vertical axis.

The four amplitude peaks observed correspond to the measurements resulting from reflections of the ultrasound signals from four reflectors of a reference part. The curves 401-406 show the calibration gain that is calculated on the basis of these measurements.

These curves are subsequently used to calibrate new signals in step 103, in order to correct the amplitude of each signal.

This correction procedure can also be applied directly to images obtained by TFM or PWI imaging as shown in FIG. 2.

In this case, the images are calculated in step 201 on the basis of the signals acquired in step 102, and are then corrected directly, using the correction curves, in step 202.

The TFM or PWI imaging methods may be used to form an image by synthetic focusing, in emission and reception, at all points of an area of interest. The correction step 202 is applied to each column of the image in order to provide the same sensitivity for each point of the image.

As can be seen in FIGS. 4a and 4b, the different gain correction curves 401-406 have different forms for small differences in angle (1°). The variations of these curves are not linear, and are sometimes abrupt, depending on the depth, for very similar angles.

Thus it is evident that this manual calibration procedure leads to imprecise results.

For this reason, an automated calibration method is proposed, requiring no measurements on a reference part nor any intervention by a human operator. The proposed calibration method is based on an estimate of the ultrasound field generated by the transducer, and of the field reflected at all points of an area to be imaged. It can be applied to different types of ultrasound imaging methods.

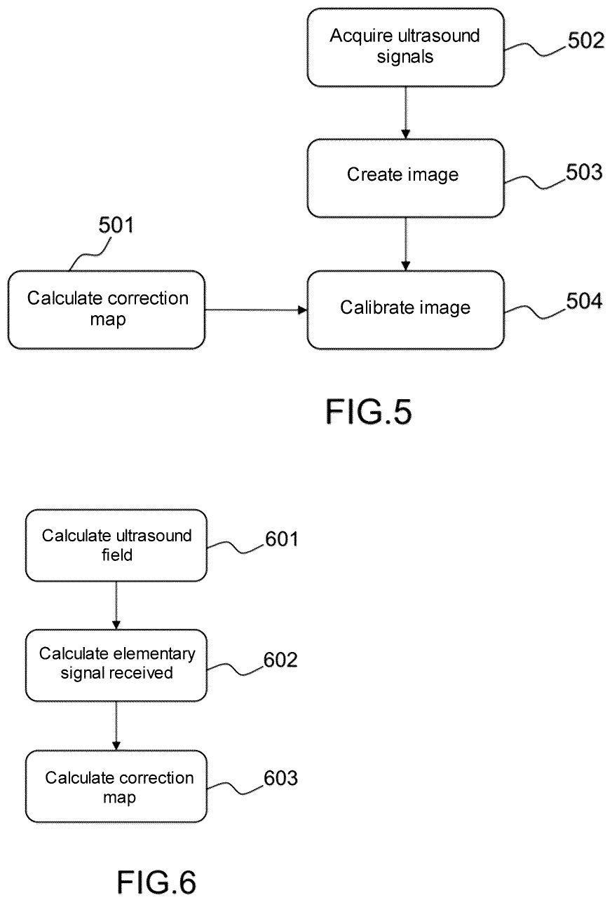

FIGS. 5, 6 and 7 describe a first embodiment of a method of automated calibration applied to an ultrasound imaging method called TFM (Total Focusing Method).

FIG. 5 describes, in a flow chart, the steps relating to the imaging method, incorporating a correction obtained by calibration.

FIG. 6 describes, in another flow chart, the steps of the implementation of the method of determining a correction map.

The TFM (Total Focusing Method) imaging method is mainly applied to ultrasonic acquisitions of the Full Matrix Capture (FMC) type, as described in reference [1]. For an ultrasound transducer comprising N elements, the FMC acquisition consists in recording a set of N×N elementary signals sᵢⱼ(t), i,j=1, . . . , N. The index i denotes the number of the emitting element and the index j denotes that of the receiving element.

The TFM imaging algorithm consists in summing the received signals in a coherent manner to find constructive interferences, and thus peaks of amplitude, at the point where the defects giving rise to the detected echoes are actually located. It is mainly based on the use of times of flight evaluated theoretically on the basis of direct models. This algorithm can then be summarized as three steps:
Defining a reconstruction area to be imaged in a given part (position, dimensions and number of points);
For each point p of the image and for each emitter-receiver pair ij, calculating the theoretical time of flight, tᵢⱼ(p)=tᵢ(p)+tⱼ(p), where tᵢ(p) is the time of flight of the ultrasonic wave between the emitter i and the point p, and tⱼ(p) is the time of flight of the ultrasonic wave between the receiver j and the point p.
For each point p of the image, summing the amplitudes extracted from the signals sᵢⱼ(t) at the times tᵢ(p)+tⱼ(p), which can be written:

$${I}_{TFM} ( p ) = {\sum }_{i , j = 1}^{N} {s}_{ij} ( {t}_{i} ( p ) + {t}_{j} ( p ) ) \qquad ( 1.1 )$$

Thus, as shown in FIG. 5, step 502 consists in performing an FMC ultrasonic acquisition, using a multi-element transducer positioned relative to a part to be imaged. This step 502 results in the acquisition of the elementary signals sᵢⱼ(t), i,j=1, . . . , N.

In step 503, the TFM method is applied to construct the image I_{TFM}(p) as indicated above.

This image is then corrected in step 504 by a calibration factor in the form of a correction map, providing, for each pixel p of the image, the correction factor C(p) to be applied:

$${I}_{TFM , corr} ( p ) = \frac{{I}_{TFM} ( p )}{C ( p )} \qquad ( 1.2 )$$

The correction map C(p) is pre-calculated in step 501 for all the pixels p corresponding to the area to be inspected. The values of C(p) are saved in a memory or a database which is interrogated in step 504 for the purpose of correcting the TFM image.

FIG. 6 shows the steps for calculating the method of determining the correction map C(p).

The first step 601 consists in estimating the ultrasonic displacement field transmitted from one point and observed at another point.

The expression Uᵢ(p, t) denotes the displacement field transmitted by the ultrasound element i and observed at the point p. It may be written in the following form:

$${U}_{i} ( p , t ) = {q}_{i} {A}_{i} ( p ) δ ( t - {t}_{i} ( p ) ) {e}^{i ϕ} \qquad ( 1.3 )$$

where Aᵢ(p) is the amplitude of the displacement vector of the wave at the point p, tᵢ(p) is the time of flight of the ultrasonic wave between the element i and the point p, p is the phase of the wave, and qᵢ is the polarization vector of the wave. This vector is normalized and represents the direction of displacement of the particles at the passage of the wave. It depends on the nature of the wave (longitudinal or transverse wave) and its direction of propagation. Those skilled in the art may consult document [2] for further details on the precise calculation of this displacement field.

The expression Uᵢ(p, t) denotes the projection of the field Uᵢ(p, t) on its polarization qᵢ:

$${U}_{i} ( p , t ) = {U}_{i} ( p , t ) \cdot {q}_{i} \qquad ( 1.4 )$$

where the operator “⋅” represents the scalar product and Uᵢ(p, t) represents the displacement field transmitted by the element i and observed at the point p defined by the formula (1.3). This projection describes the propagation of the wave from the element i towards the point p.

Similarly, the expression Uⱼ(p, t) denotes the displacement field of the wave reflected from the point p and observed (acquired) by an ultrasonic element with the index j.

The ultrasound field estimates Uᵢ(p, t) and Uⱼ(p, t) can be calculated using elastodynamic wave propagation simulation software, for example the CIVA software described in publication [5].

Using the approach proposed in reference [3], the elementary signal received by the element j with an emission by the element i in the presence of a diffraction device, assumed to be a point device, at a point p of the part is determined in step 602. This elementary signal can be approximated as the temporal convolution product of the two ultrasound fields corresponding, respectively, to the passage of the wave between the element i and the point p, and then between the point p and the element j.

$${\hat{s}}_{ij} ( p , t ) = {U}_{i} ( p , t ) * {U}_{j} ( p , t ) \qquad ( 1.5 )$$

where * represents the temporal convolution product.

Finally, in step 603, the correction gain to be applied to a TFM image for each point p is determined via the following relation:

$$C ( p ) = {\sum }_{i , j = 1}^{N} {\hat{s}}_{ij} ( p , {t}_{i} ( p ) + {t}_{j} ( p ) ) \qquad ( 1.6 )$$

where tᵢ(p) is the time of flight of the wave between the emitter i and the point p and tⱼ(p) is the time of flight of the wave between the receiver j and the point p.

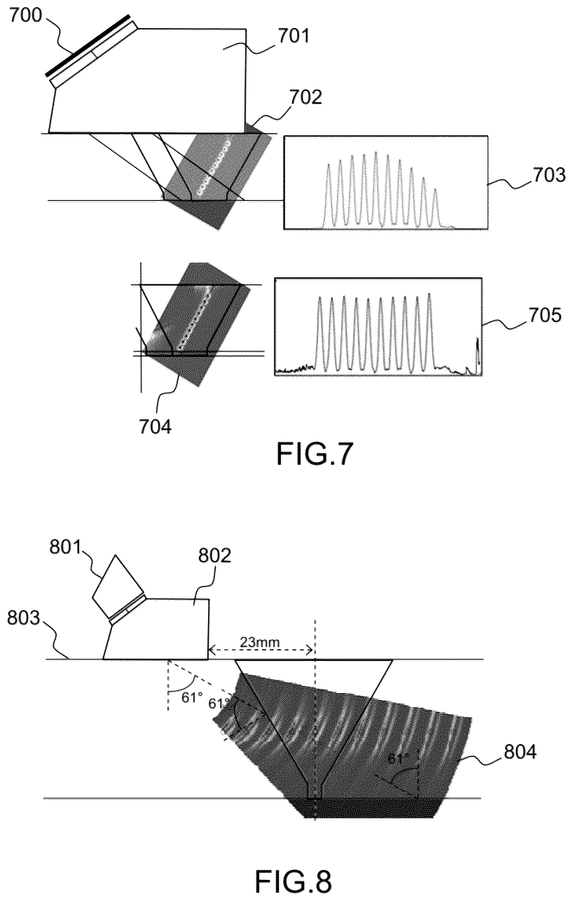

FIG. 7 shows an example of the implementation of the calibration method according to this first embodiment of the invention.

FIG. 7 shows schematically a multi-element transducer 700, positioned on a part 701 to be inspected, which comprises aligned transverse holes positioned at different depths. The image 702 corresponds to an uncorrected TFM image of the part, while the image 704 corresponds to the image corrected by using the correction gain determined in step 603. The diagrams 703 and 705 represent the intensity of the pixels of the image along a line corresponding to the alignment of the holes. It can be seen that, in the diagram 703, the amplitudes are attenuated at different levels according to the distance from the hole to the transducer. In the diagram 705, after correction, these signals are calibrated so as to be at a substantially equal full-screen height, regardless of the distance from the hole (reflector) to the transducer.

A second embodiment of the invention, applied to another type of ultrasound imaging, namely PWI (Plane Wave Imaging), will now be described.

The plane wave imaging (PWI) method is applied to an ultrasound acquisition performed with plane waves in emission. The PWI algorithm repeats all the steps of the TFM algorithm, as described in detail in reference [4]. For a transducer with N elements and M plane waves transmitted in the medium, the intensity of the PWI image at the point of calculation p is written thus:

$${I}_{PWI} ( p ) = {\sum }_{m = 1}^{M} {\sum }_{j = 1}^{N} {s}_{mj} ( {t}_{m}^{e} ( p ) + {t}_{j}^{r} ( p ) ) \qquad ( 2.1 )$$

where tₘ^{e}(p) is the time taken by the m^{e} plane wave with the angle of incidence θₘ to reach the focal point p, tⱼ^{r}(p) is the time of flight between the focal point and the receiver j, and sₘⱼ(t) is the signal received by the element j.

The steps of the corrected PWI method are similar to those of the TFM method described in FIG. 5, although the implementation of each step is adapted to the specific nature of plane wave imaging.

Thus, in step 501, an acquisition of ultrasound signals incorporating an emission of plane waves is performed.

Each plane wave is defined by an angle of incidence Om and is obtained on the basis of the set of elements of the transducer that are excited with particular emission delay laws.

To generate these plane waves, emission delay laws should first be calculated for each desired direction of propagation, in order to apply these delays to the elements of the transducer.

For a transducer with N elements and a plane wave defined by an angle of incidence θₘ,

$${τ}_{i} ( {θ}_{m} ) = {τ}_{im} , i = 1 , ... , N , m = 1 , ... , M \qquad ( 2.2 )$$

denotes the delay applied to the emission of an element of the transducer with an index of i, where M is the number of plane waves transmitted by the transducer.

For common applications, the elements of the transducer and the area to be inspected are separated by a flat interface. Then, in order to calculate the delay laws, it is simply necessary to emit a plane wave in water, with an angle of incidence α that conforms to the Snell-Descartes relation

$$( \frac{sin α}{{c}_{1}} = \frac{sin θ}{{c}_{2}} )$$

with the desired angle of refraction θ. In this case, the delay applied (in emission and reception) to an element is given by:

$${τ}_{i} ( θ ) = ( {x}_{i} sin α + {z}_{i} cos α ) \frac{1}{{c}_{1}} - {min}_{{x}_{i} , {z}_{i}} ( ( {x}_{i} sin α + {z}_{i} cos α ) \frac{1}{{c}_{1}} ) \qquad ( 2.3 )$$

where c₁ is the propagation velocity in the coupling medium located between the transducer and the part to be inspected, c₂ is the propagation velocity in the part under inspection, and (xᵢ, zᵢ) are the coordinates of the centre of the element i.

These delays are then applied to the elements of the transducer, after which an ultrasound signal acquisition sₘⱼ(t) is performed, where m corresponds to the index of the angle of incidence associated with the plane wave emitted and j corresponds to the index of an element of the transducer acting as a receiver.

In step 503, a PWI image is created on the basis of the acquired signals for the purpose of constructing the image I_{PWI}(p) given by relation 2.1.

This image is then corrected in step 504 by a calibration factor in the form of a correction map, providing, for each pixel p of the image, the correction factor C(p) to be applied:

$${I}_{PWI , corr} ( p ) = \frac{{I}_{PWI} ( p )}{C ( p )} \qquad ( 2.4 )$$

The correction map C(p) is pre-calculated in step 501 for all the pixels p corresponding to the area to be inspected. The values of C(p) are saved in a memory or a database which is interrogated in step 504 for the purpose of correcting the TFM image.

The calculation of the correction map follows steps similar to those developed for the TFM method with reference to FIG. 6.

The ultrasonic displacement field transmitted for a plane wave emitted with an angle of incidence θ and observed at the point p is calculated in step 601.

The map of the ultrasound field is calculated in emission (and in reception if the configuration of the transducer is not symmetrical).

The expression Uᵢ(p, t) denotes the displacement field transmitted by the element i of the transducer and observed at the point p defined by formula (1.4).

k(θ) denotes the direction of propagation and q(θ) denotes the polarization of the plane wave propagated at an angle of incidence θ. For longitudinal waves, the polarization q(θ) is collinear with the direction of propagation k(θ). And for transverse waves, the polarization q(θ) is orthogonal to the direction of propagation k(θ).

The expression Uᵢ(p, t) denotes the projection of the elementary field Uᵢ(p, t) on the polarization axis q(θ):

$${U}_{i} ( p , t ) = {U}_{i} ( p , t ) \cdot q ( θ ) \qquad ( 2.5 )$$

where the operator “⋅” represents the scalar product.

The field transmitted for an angle θ and observed at the point p is then expressed as the sum of the contributions of the scalar fields, Uᵢ(p, t), of each element i with the delay applied to each element:

$$U ( p , t , θ ) = {\sum }_{i = 1}^{N} {U}_{i} ( p , t - {τ}_{i} ( θ ) ) \qquad ( 2.6 )$$

Here, τᵢ(θ) is the delay applied to the element i. This projection describes the propagation of the plane wave propagated with an angle of incidence θ towards the point p.

In step 602, the elementary signal received by the element j with an emission by a plane wave with the angle of incidence θₘ in the presence of a diffraction device, assumed to be a point device, at a point p of the part, is calculated using the following approximation:

$${\hat{s}}_{mj} ( p , t ) = U ( p , t , {θ}_{m} ) * {U}_{j} ( p , t ) \qquad ( 2.7 )$$

where U(p, t, θₘ) is defined by relation (2.6) and Uⱼ(p, t) is defined by relation (2.5).

The ultrasound field estimates Uⱼ(p, t) and U(p, t, θₘ) can be calculated using elastodynamic wave propagation simulation software, for example the CIVA software described in publication [5].

Finally, in step 603, the correction map is calculated, via the following relation:

$$C ( p ) = {\sum }_{m = 1}^{M} {\sum }_{j = 1}^{N} {\hat{s}}_{mj} ( p , {t}_{m}^{e} ( p ) + {t}_{j}^{r} ( p ) ) \qquad ( 2.8 )$$

where tₘ^{e}(p) is the time taken by the m^{e} plane wave with the angle of incidence θₘ to reach the focal point p, tⱼ^{r}(p) is the time of flight between the focal point p and the receiver j.

A third embodiment of the invention, applied to what is called a conventional ultrasound imaging method based on angular scanning of the area to be imaged by plane waves, will now be described.

The principle of angular scanning inspection consists in applying different delay laws, corresponding to different angles, in succession, so as to insonify an angular sector of the part. It provides a sectoral image of the inspected area, commonly called an S-Scan. The inspection configuration is shown in FIG. 8 for an example of a part 803 comprising a plurality of identical reflectors. The transducer 801 is positioned on a shoe 802 which comes into contact with the part 803. On the S-Scan image 804 obtained by angular scanning between 43° and 79°, with an angular pitch of 1°, the amplitude responses of reflectors of identical dimensions are observed to decrease as a function of their distance from the transducer.

The calibration method according to the third embodiment of the invention is intended to correct directly the signals acquired by the transducer for each angle of incidence.

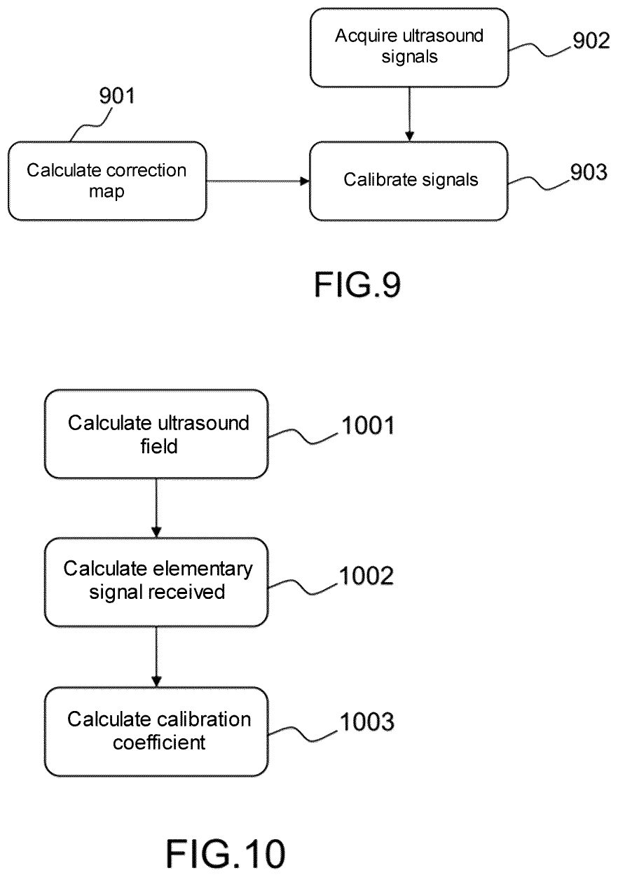

FIG. 9 shows, in a flow chart, the steps of the implementation of a method of imaging by angular scanning according to the third embodiment of the invention.

In step 902, an acquisition of signals is performed for each angle of incidence. For this purpose, as in the case of PWI imaging, a preliminary step consists in calculating delay laws to be applied to the elements of the transducer in order to emit a plane wave in the desired direction.

The delay laws are applied to emission and reception at the elements of the transducer. For a transducer with N elements and an angle of incidence of θₘ, the delay applied to emission and reception at an element is written thus:

$${τ}_{i} ( {θ}_{m} ) = {τ}_{im} , i = 1 , ... , N , m = 1 , ... , M \qquad ( 3.1 )$$

where M is the number of plane waves transmitted and received by the transducer. The delay τᵢ(θ), i=1, . . . , N is calculated by formula (2.3).

In step 903, the acquired signals are corrected using a specific calibration factor for each angular direction, this calibration factor being calculated in advance in step 901.

$${s}_{corr} ( {θ}_{m} , {t}_{i} ) = \frac{s ( {θ}_{m} , {t}_{i} )}{C ( {θ}_{m} )} \qquad ( 3.2 )$$

The set of acquired signals can be represented in the form of an S-SCAN image which shows the amplitude of the signal as a function of time and of the angle of incidence.

FIG. 10 shows, in a flow chart, the steps of the implementation of the method of calculating the calibration factors according to the third embodiment of the invention.

In step 1001, the ultrasound field transmitted for an angle of incidence θ and observed at a point p along a representative ray of the propagation of the wave at this angle of incidence is determined.

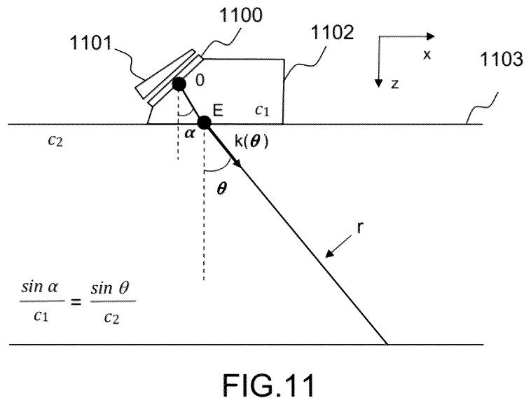

FIG. 11 shows schematically a representative ray r of the propagation of the wave emitted with an angle of incidence θ by a transducer 110 placed on a shoe 1102 in contact with a part to be inspected 1103. Delay laws 1101 are applied to the elements of the transducer 1100 to generate a plane wave with an angle of incidence of θ.

The ray r is defined by its origin E, which is the impact point of the emitted wave on the interface separating the elements of the transducer from the area to be inspected, and by the direction of propagation k(θ)=(sin θ, cos θ) as shown in FIG. 11. The ray r emerges from the centre of the transducer (point O), is refracted in the part at a refraction angle of θ and follows the Snell-Descartes law on the interface.

The field U(p, t, θ) defined by the formula (2.6) is calculated for all the points p of the ray r. It can be calculated using elastodynamic wave propagation simulation software, for example the CIVA software described in publication [5].

The coordinates of the point p=(p₁, p₂) are defined by the equation:

$${p}_{1} - {e}_{1} = tan θ ( {p}_{2} - {e}_{2} ) \qquad ( 3.2 )$$

where (e₁, e₂) are the coordinates of the impact point E.

In step 1002, the elementary signal received by the transducer with an emission by a plane wave at an angle of incidence of θ in the presence of a diffraction device, assumed to be a point device, at a point p of the part, said point p passing through the ray r, is calculated using the following relation: ŝ(tₐ(p)+tᵣ(p), θ)=U(p,t=tₐ(p), θ)*U(p,t=tᵣ(p), θ), where tₐ(p) is the time taken by the plane wave at the angle of incidence θ to reach the point p, and tᵣ(p) is the time taken by the plane wave starting from the point p to reach the transducer.

The elementary signal ŝ(tₐ(p)+tᵣ(p), θ) corresponds to outward and return travel between the transducer and the point p.

In step 1003, the correction coefficient of the acquired signal is determined for the incidence θ, as C(θₙ)=ŝ(tᵢ, θₘ) with tᵢ varying over the instants of measurement, tᵢ=tₐ(p)+tᵣ(p).

If the configuration is symmetrical, we find that tₐ(p) tᵣ(p).

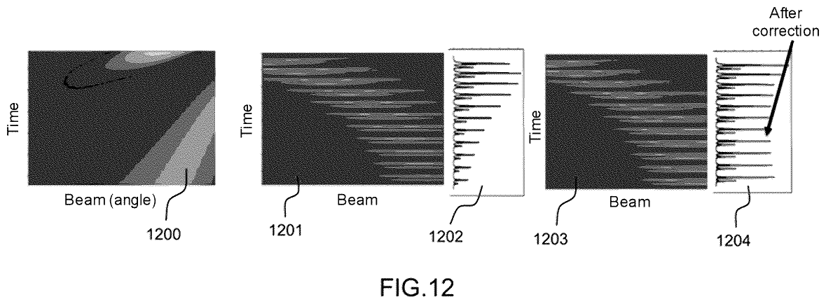

FIG. 12 shows, in an example, the result obtained with this calibration method for a part comprising a plurality of reflectors of the same dimensions, positioned at different depths.

The diagrams 1200, 1201, 1203 show amplitude as a function of time and of an angle of incidence.

Diagram 1200 shows a map of the calibration gain determined by the method of FIG. 10.

Diagram 1201 shows an S-SCAN map of an acquisition of ultrasound signals without correction. Diagram 1202 shows the amplitudes of the signals corresponding to the reflectors of the part. It can be seen that the amplitude varies according to the depth (equivalent to the time).

Diagram 1203 shows the map 1201 corrected by the calibration gain 1200. Diagram 1204 shows the same amplitudes as diagram 1202, but after correction by the calibration gain. It can be seen that the calibration enables the amplitude of the signals to be adjusted to the same level for all the reflectors, regardless of their depth in the part.

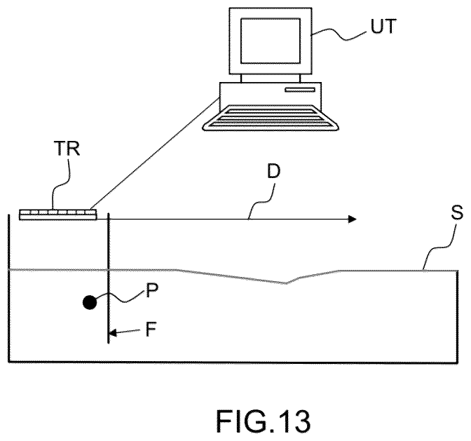

FIG. 13 shows a diagram of an ultrasound inspection system configured for implementing the invention.

The system mainly comprises a multi-element ultrasound transducer TR and a processing unit UT. The transducer TR may have different subdivision geometries; for example, it may be a linear, matrix, annular or sectoral sensor. Each element of the ultrasound transducer may be formed by a piezoelectric sensor or any other type of sensor capable of emitting and receiving an ultrasonic wave.

The transducer TR is controlled by the processing unit UT in order to image an area F of a structure S to be inspected. For this purpose, the transducer TR may perform a plurality of acquisitions while moving over the surface of the part, for example along a direction of displacement D. The inspection system enables the structure S to be imaged at any point P.

The method of generating calibration coefficients or a correction map according to any of the embodiments of the invention can be implemented by the processing unit UT. To this end, it may be executed as a computer program. More generally, this method may be implemented by means of software and/or hardware elements such as a processor and a memory.

The imaging method, including the calibration of the signals acquired by the transducer TR, can be implemented using the transducer TR and the processing unit UT. Typically, the previously calculated calibration coefficients are saved by the processing unit UT, which comprises a memory or database, and are used for correcting the signals acquired by the transducer TR or for correcting the image constructed by the processing unit UT on the basis of the signals acquired by the transducer TR.

### REFERENCES

[1]C. Holmes, B. W. Drinkwater, P. D. Wilcox, Post-processing of the full matrix of ultrasonic transmit-receive array data for non-destructive evaluation, NDT&E international, Vol. 38, pp. 701-711, 2005.
[2] El Amrani, M., Calmon, P., Roy, O., Royer, D., & Casula, O. (1995). The ultrasonic field of focused transducers through a liquid-solid interface. In Review of Progress in Quantitative Nondestructive Evaluation: Volume 14 (pp. 1075-1082). Boston, MA: Springer US.
[3] Lingvall, F. (2004). A method of improving overall resolution in ultrasonic array imaging using spatio-temporal deconvolution. Ultrasonics, 42(1-9), 961-968.
[4] Le Jeune, L., Robert, S., Villaverde, E. L., & Prada, C. (2016). Plane wave imaging for ultrasonic non-destructive testing: Generalization to multimodal imaging. Ultrasonics, 64, 128-138.
[5] CIVA: An expertise platform for simulation and processing NDT data, Ultrasonics volume 44 Supplement, 22 Dec. 2006, Pages e975-e979, Proceedings 10 of Ultrasonics International (UI′05) and World Congress on Ultrasonics (WCU).

1. A computer-implemented method for the calibration of ultrasound signals acquired by a multi-element ultrasound transducer for the purpose of imaging an area of interest, the method comprising the steps of:
estimating an ultrasound field emitted from the transducer towards any point P of said area,
estimating an ultrasound field, originating from said point P, acquired by the transducer,
determining an elementary signal received by the transducer on the basis of the emitted ultrasound field and the acquired ultrasound field,
determining on the basis of said elementary signal, for each point P of said area, a calibration coefficient to be applied to the signals received by an ultrasound transducer in order to image said area, or to an ultrasound image obtained on the basis of said received signals.

2. The calibration method according to claim 1, further comprising the steps of:
performing ultrasound imaging of the area of interest by means of the ultrasound transducer,
correcting the signals received by the ultrasound transducer or the image determined on the basis of said signals, using the calculated calibration coefficients.

3. The calibration method according to claim 1, wherein the steps of estimating an ultrasound field comprise the projection of the estimated ultrasound field on to a polarization vector of the ultrasonic wave.

4. The calibration method according to claim 1, wherein:
the elementary signal associated with a pair of elements (emitter and receiver) of the transducer is taken to be equal to the temporal convolution product of the ultrasound field emitted from the emitter element towards the point P and the ultrasound field acquired by the receiver element from the point P,
the calibration coefficient is taken to be equal to the sum, over the set of elements of the transducer, of the values of the elementary signal taken at instants equal to the sum of the time of flight of an ultrasonic wave between an emitter element of the transducer and the point P and the time of flight of an ultrasonic wave between the point P and a receiver element of the transducer,
the calibration coefficient being applied to the pixel, corresponding to the point P, of an ultrasound image obtained via a total focusing method.

5. The calibration method according to claim 1, wherein the ultrasound transducer is capable of emitting a plane wave at a given angle of incidence, and the ultrasound field emitted by the transducer at the angle of incidence towards the point P is taken to be equal to the sum of the values of the ultrasound fields emitted from an element of the transducer towards the point P, taken at an instant delayed by a predefined delay so that the transducer emits a plane wave at said angle of incidence.

6. The calibration method according to claim 5, wherein:
the elementary signal associated with a pair (angle of incidence, receiver element of the transducer) is taken to be equal to the temporal convolution product of the ultrasound field emitted by the transducer at the angle of incidence towards the point P and the ultrasound field acquired by the receiver element from the point P,
the calibration coefficient is taken to be equal to the sum, over a plurality of angles of incidence and the set of elements of the transducer, of the values of the elementary signal taken at instants equal to the sum of the time of flight of a plane wave emitted at a given angle of incidence towards the point P and the time of flight of an ultrasonic wave between the point P and a receiver element of the transducer,
the calibration coefficient being applied to the pixel, corresponding to the point P, of an ultrasound image obtained via a plane wave ultrasound imaging method.

7. The calibration method according to claim 1, wherein the ultrasound image is a sum of the signals acquired by the elements of the transducer taken at the times of flight corresponding to a point P of the area to be imaged.

8. The calibration method according to claim 5, wherein:
the elementary signal associated with an angle of incidence is taken to be equal to the temporal convolution product of the ultrasound field emitted by the transducer at the angle of incidence towards a point located on a representative ray of the propagation of the plane wave and the ultrasound field emitted from said point towards the transducer,
each ultrasound signal acquired by the transducer for a given angle of incidence and a given time of flight is corrected by the calibration coefficient taken to be equal to the elementary signal taken at an instant equal to the time of flight.

9. The calibration method according to claim 8, wherein the ultrasound image is defined by a representation of the signals acquired as a function of the angle of incidence and the time of flight.

10. An ultrasound imaging device comprising a multi-element ultrasound transducer and a processing unit, configured for implementing the steps of the calibration method according to claim 1.

11. A computer program comprising instructions which cause an ultrasound imaging device comprising a multi-element ultrasound transducer and a processing unit, configured for implementing the steps of the calibration method according to claim 1, to execute the steps of the calibration method according to claim 1, when said program is executed on a computer.
